(19) United States
(12) Patent Application Publication
(10) Pub. No.: US 2019/0069495 A1
(43) Pub. Date: Mar. 7, 2019

(54) RAISED GARDEN BED

(71) Applicant: David A. Kobe, Helper, UT (US)

(72) Inventor: David A. Kobe, Helper, UT (US)

(21) Appl. No.: 16/117,493

(22) Filed: Aug. 30, 2018

Related U.S. Application Data
(60) Provisional application No. 62/555,521, filed on Sep. 7, 2017.

(51) Int. Cl. A01G 9/28; F16B 5/06

(52) U.S. Cl. CPC A01G 9/28; F16B 2005/0678; F16B 5/0614

(57) ABSTRACT

A raised garden bed system is comprised of a plurality of corner members configured for adjoining a plurality of plank members. The corner members are configured to be stackable on top of one another and to hold two adjacent ends of the planks at an angle relative to one another.

### CROSS-REFERENCE TO RELATED APPLICATION

The present application claims priority to U.S. Provisional Patent Application Ser. No. 62/555,521 filed on Sep. 7, 2017, the entirety of which is incorporated by this reference.

### BACKGROUND OF THE INVENTION

### Field of the Invention

The present invention relates generally to devices and systems for forming a raised garden bed and more specifically to a frame system for forming a raised garden bed.

### State of the Related Art

Prior art raised garden beds are typically formed by joining a plurality of wood planks or boards together to form a rectangular box, within which soil is placed for growing various plants. The prior art raised garden beds, however, require various carpentry skills in order to create a raised garden bed that is structurally sound and aesthetically pleasing. Thus, there exists a need in the art to provide a system for forming a raised garden bed structure that is easy and inexpensive to manufacture and easy to assemble.

### SUMMARY OF THE INVENTION

The present invention is directed to a raised garden bed having a first plurality of corner brackets. Each of the corner brackets defines a first slot and a second slot. The first and second slots are oriented at an angle relative to one another of between 30 degrees and 150 degrees. Each of a plurality of planks are inserted into the first slot of one of the plurality of corner brackets and the second slot of another of the plurality of corner brackets to form a raised garden bed.

The raised garden bed of the present invention includes a second plurality of corner brackets. Each of the second corner brackets also defines a first slot and a second slot. The first and second slots are oriented at an angle relative to one another that is the same as the angle of the first and second slots of the first corner bracket. The second plurality of corner brackets are stacked upon the first plurality of corner brackets.

Each of a second plurality of planks are inserted into the first slot of one of the second plurality of corner brackets and the second slot of another of the plurality of second corner brackets. The second plurality of planks are stacked upon the first plurality of planks.

In one embodiment, each of the plurality of corner brackets comprise a body having a first surface, a second surface opposite the first surface, an outer wall and an inner wall. The inner and outer walls have a wall height between the first surface and the second surface. The first slot comprises a first vertically oriented and generally rectangular slot defined by the body between the outer wall and the inner wall at a first side of the body and extends between the first surface and the second surface. The second slot comprises a second vertically oriented and generally rectangular slot defined by the body between the outer wall and the inner wall at a second side of the body and extends between the first surface and the second surface.

Each of the plurality of corner brackets define at least one vertically oriented bore proximate to and proximately between a first closed end of the first slot and a second closed end of the second slot. The vertically oriented bore extends through the body between the first surface and the second surface.

A rod is sized to fit within the vertically oriented bore and has a length sufficient to extend from at least the first surface of the body and protrude from the second surface of the body.

In one embodiment, a protrusion extends from the first surface and a corresponding recess is formed on the second surface that is vertically aligned with and has a similar configuration to the protrusion on the first surface. The protrusion is configured to mate with the corresponding recess of a second body when vertically stacked.

In another embodiment, a first plurality of teeth inwardly depend from first inner sidewalls of the first slot and a second plurality of teeth inwardly depend from second inner sidewalls of the second slot. The first and second plurality of teeth are configured to engage a respective plank inserted therein between.

In yet another embodiment, the outer wall has a generally curved configuration and extends between a first opening at a first outer side of the first slot and a second opening at a second outer side of the second slot. The inner wall extends between a first inner side at the first opening of the first slot and a second inner side at the first opening of the second slot.

In still another embodiment, a pair of vertically oriented bores proximate to and proximately between the first closed end of the first slot and the second closed end of the second slot extend through the body between the first surface and the second surface.

In yet another embodiment, a pair of cylindrical protrusions, each concentric with a respective one of the pair of bores, extend from the first surface of the body. A pair of cylindrical recesses, each concentric with a respective one of the pair of bores, are recessed into the second surface of the body and having a diameter configured to receive a respective one of the pair of cylindrical protrusions from another body stacked thereon so as to engage with and prevent horizontal movement between adjacent bodies in a vertically stacked arrangement. A pair of rods, each received in one of the pair of bores, has a length sufficient to couple a plurality of bodies in a vertically stacked arrangement.

### BRIEF DESCRIPTION OF THE DRAWINGS

When considered in connection with the following illustrative figures, a more complete understanding of the present invention may be derived by referring to the detailed description. In the figures, like reference numbers refer to like elements or acts throughout the figures. Various embodiments of the present invention are shown and described in reference to the numbered drawings.

FIG. 1 is a perspective top side view of a raised garden bed system in accordance with the principles of the present invention;

FIG. 2A is a perspective top side view of a raised garden bed corner member in accordance with the principles of the present invention;

FIG. 2B is a top side view of the raised garden bed corner member shown in FIG. 2A;

FIG. 2C is a back side view of the raised garden bed corner member shown in FIG. 2A;

FIG. 2D is a front side view of the raised garden bed corner member shown in FIG. 2A;

FIG. 3 is a front side view of another embodiment of a raised garden bed corner member in accordance with the principles of the present invention;

FIG. 4 is a front side view of yet another embodiment of a raised garden bed corner member in accordance with the principles of the present invention;

FIG. 5 is a front side view of another embodiment of a raised garden bed system in accordance with the principles of the present invention;

FIG. 6A is a perspective top side view of another embodiment of a raised garden bed corner bracket in accordance with the principles of the present invention;

FIG. 6B is a perspective bottom side view of the raised garden bed corner bracket shown in FIG. 6A;

FIG. 7 is a top side view of yet another embodiment of a raised garden bed corner bracket in accordance with the principles of the present invention;

FIG. 8 is a top side view of another embodiment of a raised garden bed using the corner brackets shown in FIG. 7;

FIG. 9 is a top side view of another embodiment of a raised garden bed corner bracket in accordance with the principles of the present invention.

FIGS. 10A and 10B are perspective top side and bottom side views, respectively, of yet another embodiment of a raised garden bed corner bracket in accordance with the principles of the present invention; and

FIG. 11 is a perspective top side view of another embodiment of a raised garden bed system in accordance with the principles of the present invention.

FIG. 12A is a perspective top view of yet another embodiment of a raised garden bed corner bracket in accordance with the principles of the present invention.

FIG. 12B is a perspective bottom view of the raised garden bed corner bracket shown in FIG. 12A.

FIG. 12C is a top side view of the raised garden bed corner bracket shown in FIGS. 12A and 12B.

FIG. 12D is a bottom side view of the raised garden bed corner bracket shown in FIGS. 12A and 12B.

FIG. 12E is a front side view of the raised garden bed corner bracket shown in FIGS. 12A and 12B.

FIG. 12F is a back side view of the raised garden bed corner bracket shown in FIGS. 12A and 12B.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. Elements and acts in the figures are illustrated for simplicity and have not necessarily been rendered according to any particular sequence or embodiment.

### DETAILED DESCRIPTION OF THE ILLUSTRATED EMBODIMENTS

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112, ¶6. Thus, the use of the words “function,” “means” or “step” in the Detailed Description of the Invention or claims is not intended to somehow indicate a desire to invoke the special provisions of 35 U.S.C. § 112, ¶ 6, to define the invention. To the contrary, if the provisions of 35 U.S.C. § 112, ¶ 6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. § 112, ¶ 6. Moreover, even if the provisions of 35 U.S.C. § 112, ¶ 6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. Thus, the full scope of the inventions is not limited to the examples that are described below.

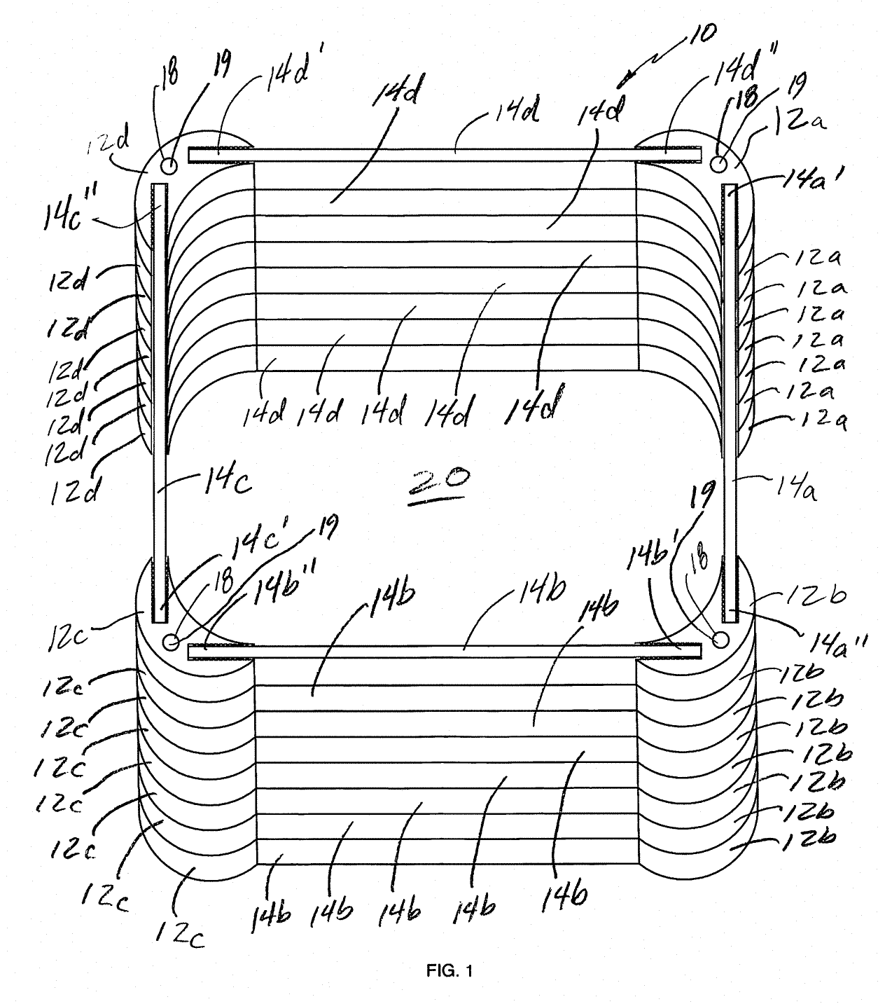

FIG. 1 illustrates a raised garden bed system, generally indicated at 10, in accordance with the principles of the present invention. The raised garden bed system is comprised of a plurality of corner members 12a-12d configured for adjoining a plurality of plank members 14a-14d. The corner members 12a-12d are configured to be stackable on top of one another and to hold two adjacent ends 14a′ and 14a″ at an angle relative to one another. In addition, each of the corner members 12a-12d are similarly configured and may be formed by molding, casting or other methods known in the art. The corner members 12a-12d may be formed from plastic, rubber, wood, concrete, composite materials or other materials known in the art. In the embodiment of the raised garden bed system illustrated in FIG. 1, the corner members 12a-12d are configured to hold respective planks 14a-14d at a 90 degree angle relative to one another. The plank members 14a-14d may be formed from plastic, wood, concrete, composite materials or other materials known in the art.

The arrangement of four corner members 12a-12d with four plank members 14a-14d as illustrated forms a rectangular raised garden bed. In this rectangular configuration, the plank members 14a and 14c have approximately the same length and plank members 14b and 14d have approximately the same length, with the respective lengths being selected by a user in order to form a raised garden bed system 10 having the desired size. In practice, the only limitation on the length of the plank members 14a-14d is that the planks are not excessively long in comparison to their thickness such that the plank members 14a-14b become excessively bowed when the space 20 defined between the corner members 12a-12d and plank members 14a-14d are filled with soil. That is, the length of the plank members 14a-14d is only limited by the structural integrity that is achieved by the corner members 12a-12d and plank members 14a-14d when under load.

In order to form the raised garden bed system 10 of a greater height than a single row of corner members 12a-12d and planks 14a-14d, the corner members 12-a-12d and planks 14a-14d can be stacked upon each other as illustrated. In order to maintain the relative positions of the corner members 12a-12d relative to one another, each corner member 12a-12d defines a centrally located vertical hole 18 there through. Each of the vertical holes 18 for each set of corner members 12a-12b are substantially vertically aligned to receive an elongate rod 19 that is inserted into the vertical holes 18 of each of the corner members 12a-12d. As will be described in more detail, the rod 19 can then be driven into the ground upon which the raised garden bed system is placed so that the corner members 12a-12d become anchored to the ground. In addition, as will be described in more detail, each corner member 12a-12d includes two receiving slots for receiving respective adjoining ends of respective plank members 14a-14d. The slots are provided with plank member engaging teeth that form a friction fit and/or mechanical engagement between the corner members 12a-12d and the plank members 14a-14d. The coupling of the corner members 12a-12d to respective planks 14a-14d prevents the corner members 12a-12d from moving relative to, and/or becoming decoupled from, the planks 14a-14d when the corner members 12a-12d and planks 14a-14d are placed under load, especially when the raised garden bed system 10 of the present invention is made to be sufficiently tall that the rod 19 could become outwardly bowed from bottom to top.

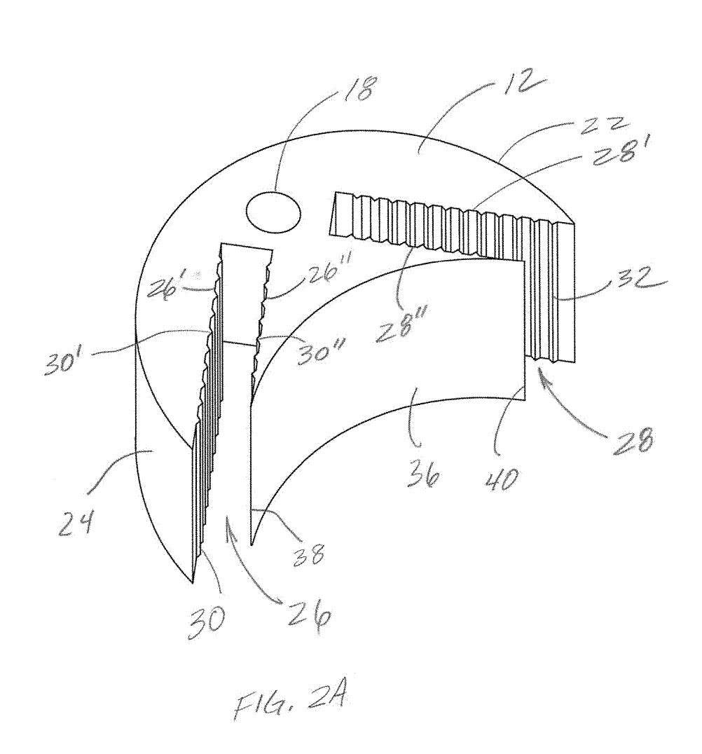

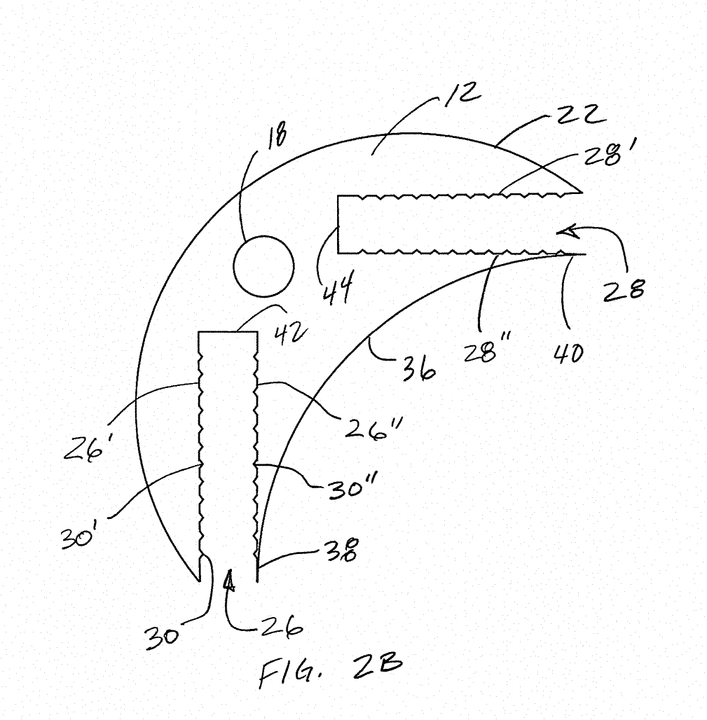

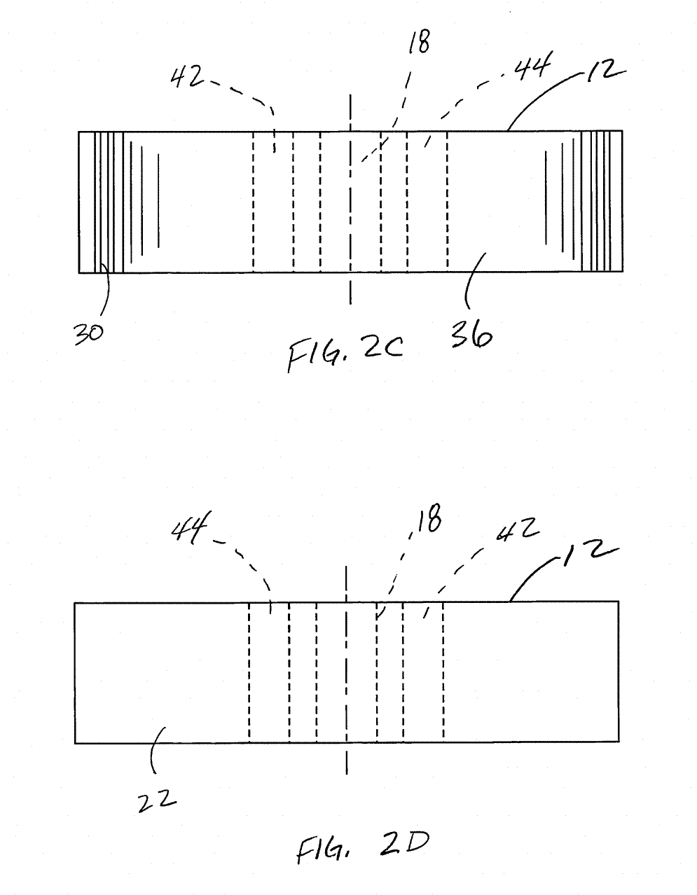

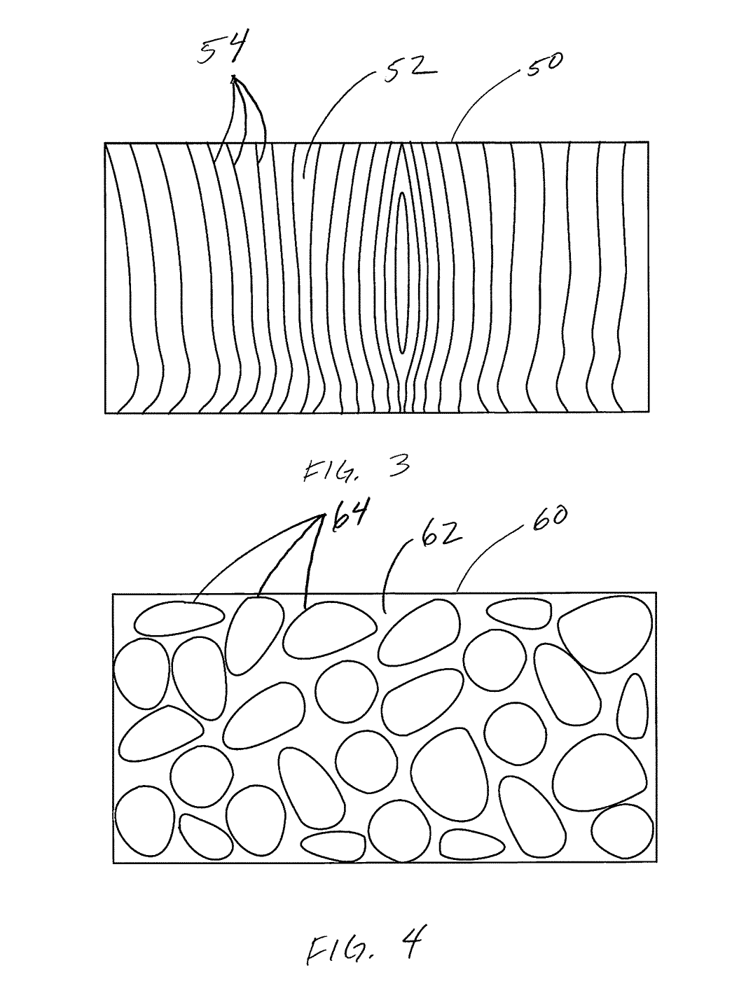

As shown in FIGS. 2A-2D, the corner member 12 of the present invention is comprised a single piece of material having a partial cylindrical shape. That is, the outer surface 22 of the corner member 12 forms a partial cylinder wall 24 having a height that is substantially equal to a height of a corresponding plank member (see FIG. 1). For example, and not by way of limitation, the height of the wall 24 may be 3.5 inches to match a height of a standard 1 in.×4 in. wood board or 5.5 inches to match a height of a standard 2 in.×6 in. wood board available at most lumber stores.

The corner member 12 defines a pair of plank slots 26 and 28 sized to receive a respective plank member (see FIG. 1). Each slot 26 and 28 is generally rectangular shaped. The inner surfaces 26′ and 26″ of slot 26 include a plurality of vertically extending protrusions or teeth 30 that are configured to engage with respective side walls of the plank member inserted therein (see FIG. 1) in order to securely hold the plank member relative to the slot 26. Similarly, the inner surfaces 28′ and 28″ of slot 28 include a plurality of vertically extending protrusions or teeth 32 that are configured to engage with respective side walls of the plank member inserted therein (see FIG. 1) in order to securely hold the plank member relative to the slot 28. The teeth 30 and 32 are vertically oriented to resist horizontal separation between the corner member 12 and respective plank members retained in the slots 26 and 28. In order to properly engage the plank members inserted into the slots 26 and 28, the distance between teeth 30′ and 30″ are less than a width of the plank member to be inserted in the slot 26. Thus, if the corner member 12 is configured with slots 26 and 28 for receiving a standard 1 in.×4 in. wood board, which has a width of 0.75 in., the distance between teeth 30′ and 30″ may be between about 0.6 inches to about 0.7. Similarly, if the corner member 12 is configured with slots 26 and 28 for receiving a standard 2 in.×6 in. wood board, which has a width of 1.5 in., the distance between teeth 30′ and 30″ may be between about 1.35 inches to about 1.45 inches so that the teeth 30′ and 30″ all along the slot 30 will engage the plank. The teeth 32 of slot 28 are similarly configured for engaging with a corresponding plank. The overall width of the slots 26 and 28, not including the teeth, may be slightly wider than the respective plank to be received therein so that the plank can be fully inserted into the slot. It should be further noted, however, that while the slots 26 and 28 have been shown to be of the same width, the slots 26 and 28 may be configured with different widths to accommodate different sized plank members if desired. The width of the slots 26 and 28 may also be dictated, to some extent, by the material used to form the corner member 12. For example, when forming the corner member 12 from a more flexible material, such as EVA, nylon or other more flexible materials known in the art, the slots may have a width that is the same or slightly smaller than a width of the plank to form a friction-type fit.

As further illustrated, the inner wall 36 of the corner member 12 is inwardly rounded between the proximal end 38 of slot 26 and proximal end 40 of slot 28. The inner wall 36 forms a semi-circle of approximately 90 degrees. The outer wall 24 forms a semi-circle of approximately 180 degrees. The semi-cylindrical shape of the outer wall 22 provides structural support to the outer side walls 26′ and 28′ of the slots 26 and 28, respectively, to prevent the outer side walls 26′ and 28′ of the slots 26 and 28, respectively, from widening the slots 26 and 28 when placed under load by plank members inserted therein. The rounded shape of the outer wall 22 also reduces stress on the corner member 12 at the distal ends 42 and 44 of the slots 26 and 28, respectively. To further reduce such stress, the distal ends 42 and 44 of the slots 26 and 28 may be semi-cylindrical in shape rather than rectangular as illustrated.

The corner member 12 also includes vertically extending hole 18 that is sized to receive a connecting rod as will be further described. The hole 18 is centrally located between the distal ends 42 and 44 of slots 26 and 28, respectively. The hole 18 is also positioned to substantially maximize the amount of material between the distal ends 42 and 44 and the hole 18, thereby in turn maximizing the structural integrity of the corner member 12.

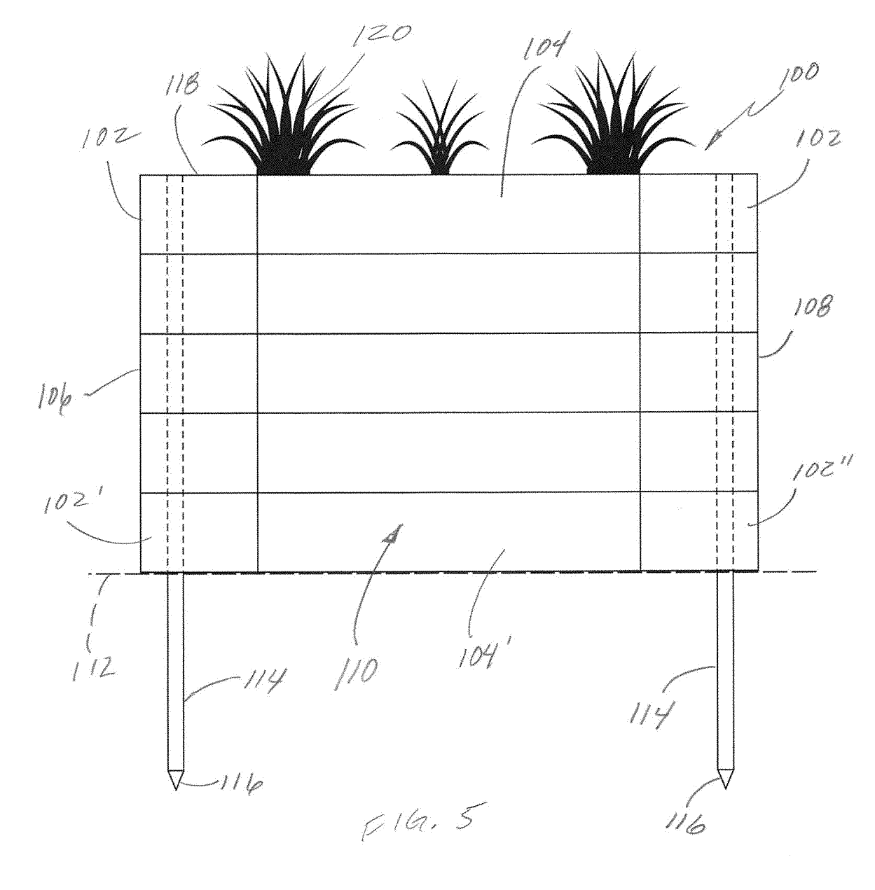

As shown in FIGS. 3 and 4, the outer wall surfaces of a corner member according to the principles of the present invention, may be provided with various surface textures to simulate the look of other materials. For example, in FIG. 3, a corner member 50 according to the present invention includes an outer surface 52 that includes surface contours 54 that simulate the look of wood grain. In FIG. 4, a corner member 60 according to the present invention includes an outer surface 62 that includes surface contours 64 that simulate the look of small stones. It is contemplated that the contour and pattern of the outer surface of the corner members may be made to look like other materials, such as brick, stone or other common building materials.

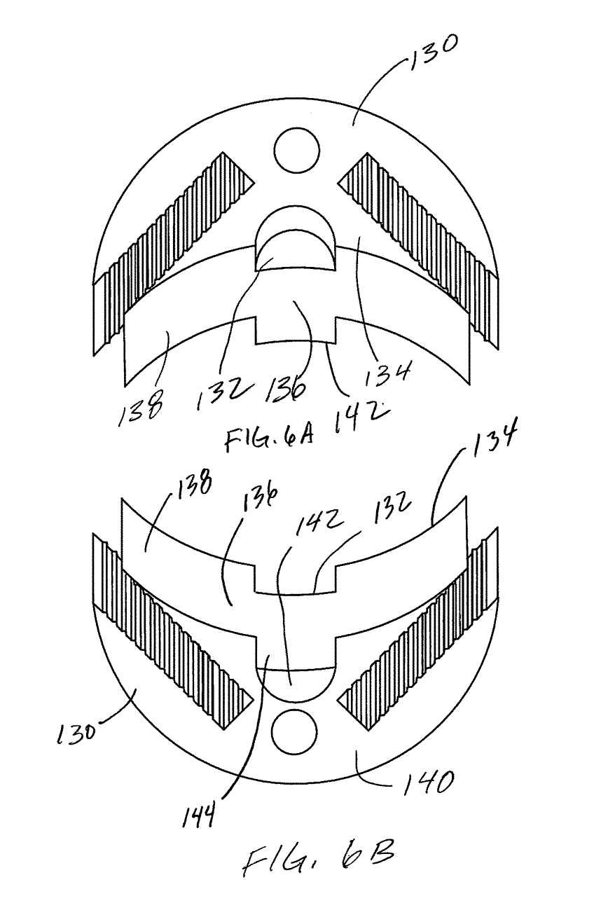

Referring now to FIG. 5, there is illustrated a fully assembled raised garden bed 100 in accordance with the principles of the present invention. The raised garden bed 100 is comprised of a plurality of corner brackets 102 coupled to a plurality of boards 104 that extend between the corner brackets 102. Each set of corner brackets 102 that define a corner 106 and 108 of the raised garden bed 100 are stacked upon each other as illustrated. Likewise, the corresponding boards 104 that span between the corner brackets 102 are stacked upon one another to form a side wall 110 of the raised garden bed 100. The bottom most corner brackets 102′ and 102″ as well as the bottom most board 104′ rest upon a support surface 112, which in this illustrated embodiment is comprised of ground. In order to hold each of the corner brackets 102 that are stacked upon one another in relative position and to maintain the position of these corner brackets 102 in position relative to the ground 112, elongated rods, stakes or tubes 114 are inserted into and through the corner brackets 102 and may be driven into the ground 112. The ends 116 of the stakes may be tapered to facilitate the stakes 114 being driven into the ground 112. The stakes may be formed from steel in a cylindrical rod configuration, a length of rebar, pipe, such as PVC pipe, and/or other materials known in the art. The stake 114 extends from proximate a top surface 118 of the uppermost corner bracket 102, through each of the corner brackets stacked below the uppermost corner bracket 102, and into the ground 112 to interconnect the corner brackets 102 and anchor the corner brackets 102 and thus the raised garden bed 100 to the ground 112. Once all four sides of the raised garden bed 100 are similarly assembled, the raised garden bed 100 can be filled with soil and plants 120 can then be planted in the soil.

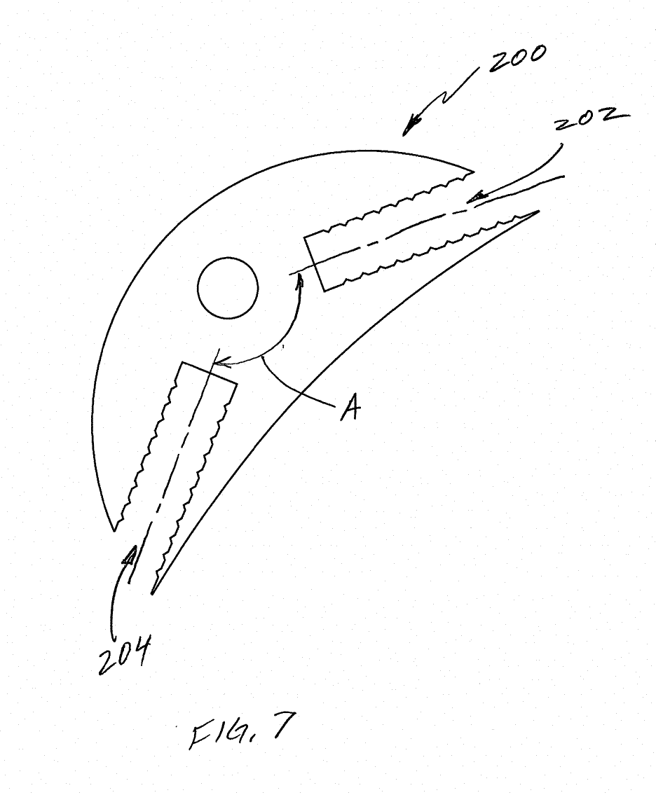

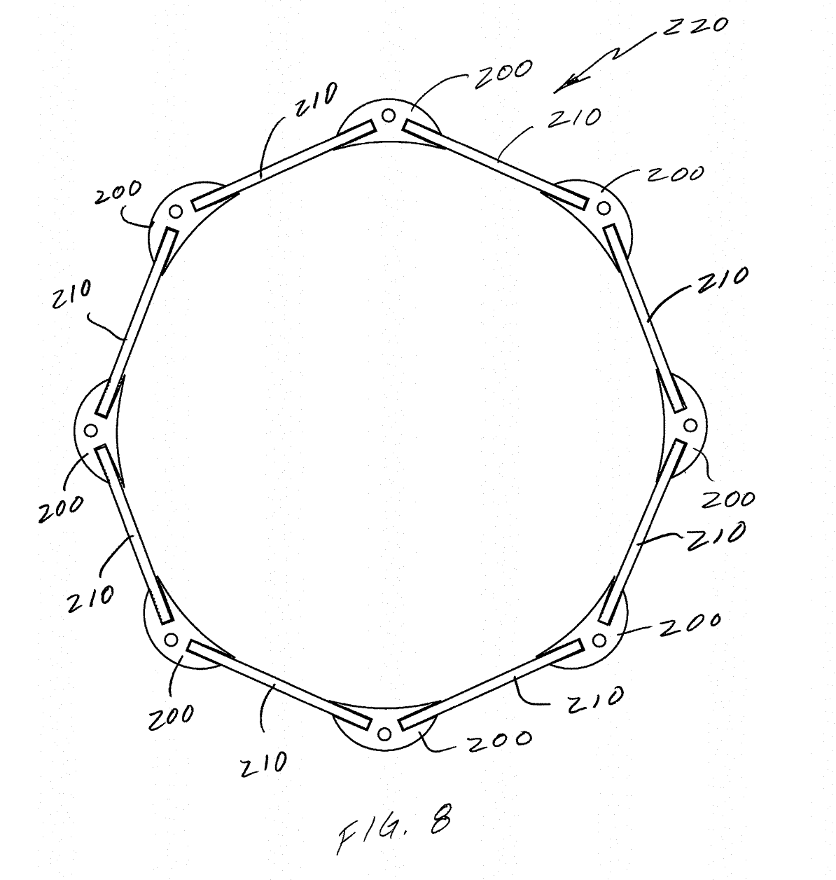

Referring now to FIGS. 6A and 6B, there is illustrated another embodiment of a raised garden bed corner bracket 130 in accordance with the present invention. The corner bracket 130 is similar in configuration to the corner bracket member 102 illustrated in FIG. 2A, but includes an upper recess 132 defined by the upper surface 134 and the inner wall 136. The recess 132 has a semi-cylindrical shape and is open to the surface 138 defined by the inner wall 136. Conversely, the lower surface 140 includes a protrusion 142 that extends from the lower surface 140 and defines an inner wall surface 144 that is coextensive with the inner wall surface 138. The protrusion 142 also has a semi-cylindrical shape that is slightly smaller than the semi-cylindrical shape of the recess 132 so that the protrusion 142 can fit within the recess 132 in a male-female type relationship of an adjacent corner bracket that is stacked above or below the corner bracket 130. The engagement of the protrusion 142 with the recess 132 provides a mechanical interlock between adjacent corner brackets when stacked as previously described to both orient adjacent corner brackets relative to one another as well as add structural integrity to the stacked corner brackets. It is noted that while the protrusion 142 and recess 132 have been shown and described as being semi-cylindrical in shape, other shapes and configurations of protrusions and corresponding mating recesses are contemplated herein, including without limitation triangular, rectangular, circular, oblong, hexagonal or other symmetrical or nonsymmetrical shapes.

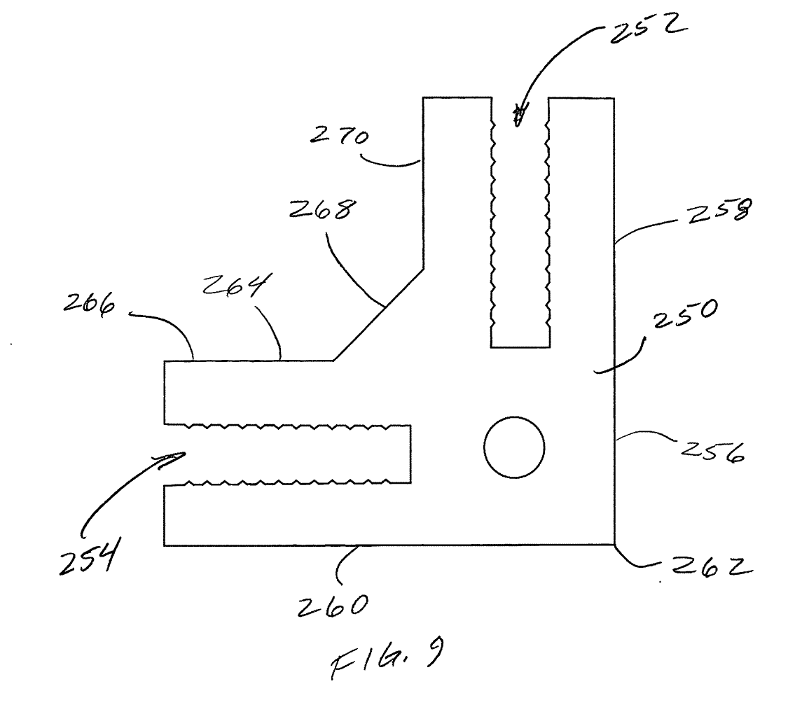

Referring now to FIG. 7, there is illustrated another embodiment of a corner bracket, generally indicated at 200, in accordance with the principles of the present invention. The corner bracket 200 has a similar configuration as the corner bracket member 102 shown in FIG. 2A except that the board retaining slots 202 and 204 are oriented at an angle of about 135 degrees relative to one another, as defined by angle A between the long axes of slots 202 and 204. As shown in FIG. 8, the corner bracket 200, when assembled with other similarly configured corner brackets and interposed boards 210 of approximately equal length, a raised garden bed 220 having an octagonal shape can be formed as illustrated. It will be apparent to those of skill in the art that the corner brackets 200 can be formed with slots 202 and 204 at various angles in order to form raised garden beds of different shapes, such as triangular, pentagon, hexagon, etc. In addition, corner brackets of one configuration can be combined with corner brackets of another configuration to form variously shaped raised garden beds, such as trapezoidal, semi-circular, etc.

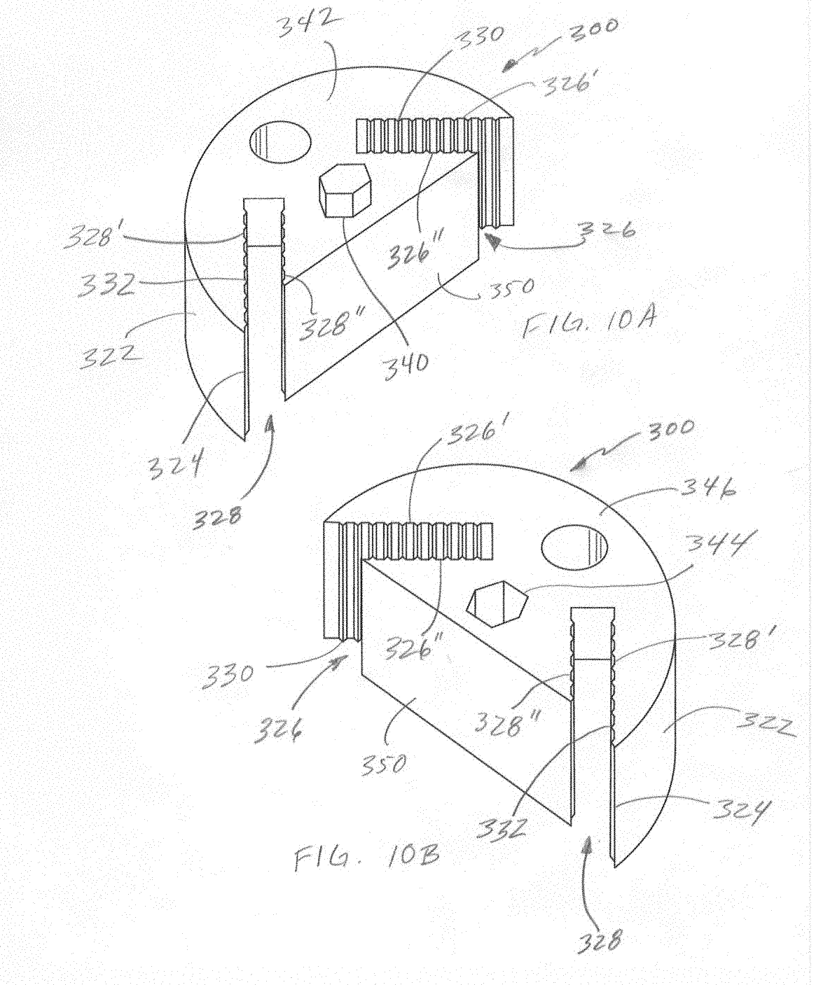

FIG. 9 illustrates yet another embodiment of a raised garden bed corner bracket 250 in accordance with the principles of the present invention. The corner bracket 250 is more rectangular in shape than the cylindrically shaped corner bracket 102 illustrated in FIG. 2A, but includes similar slots 252 and 254 for receiving side boards as previously shown and described herein. The outer wall 256 of the corner bracket 250 is comprised of two outer surfaces 258 and 260 that come together at a 90 degree angle at corner 262. This will give the corresponding raised garden bed, when assembled as previously shown and described herein, a more angular outer appearance. The functionality of the corner bracket 250, however, remains essentially the same. The inner wall surface 264 may also be more angularly configured with three inner surfaces 266, 268 and 270, which are angled relative to one another at approximately 135 degrees, defining the inner wall surface 264.

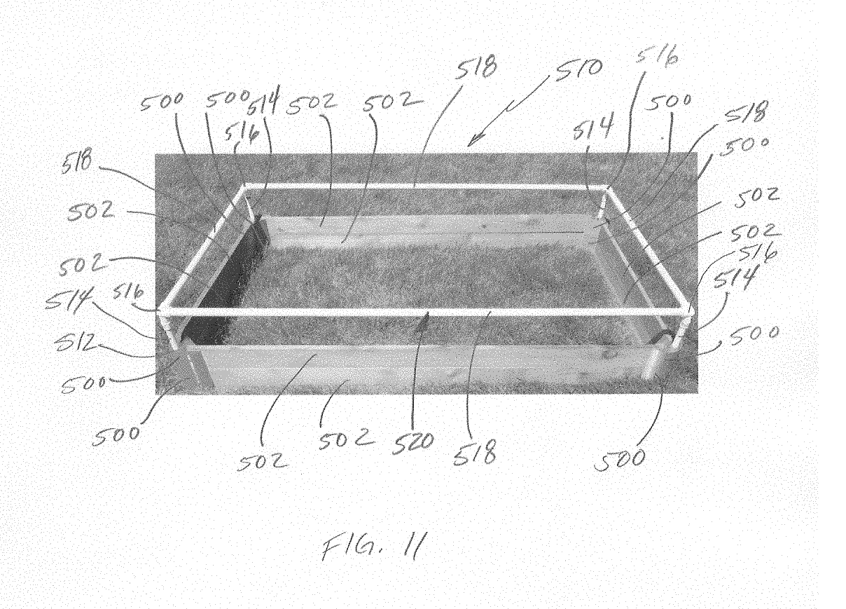

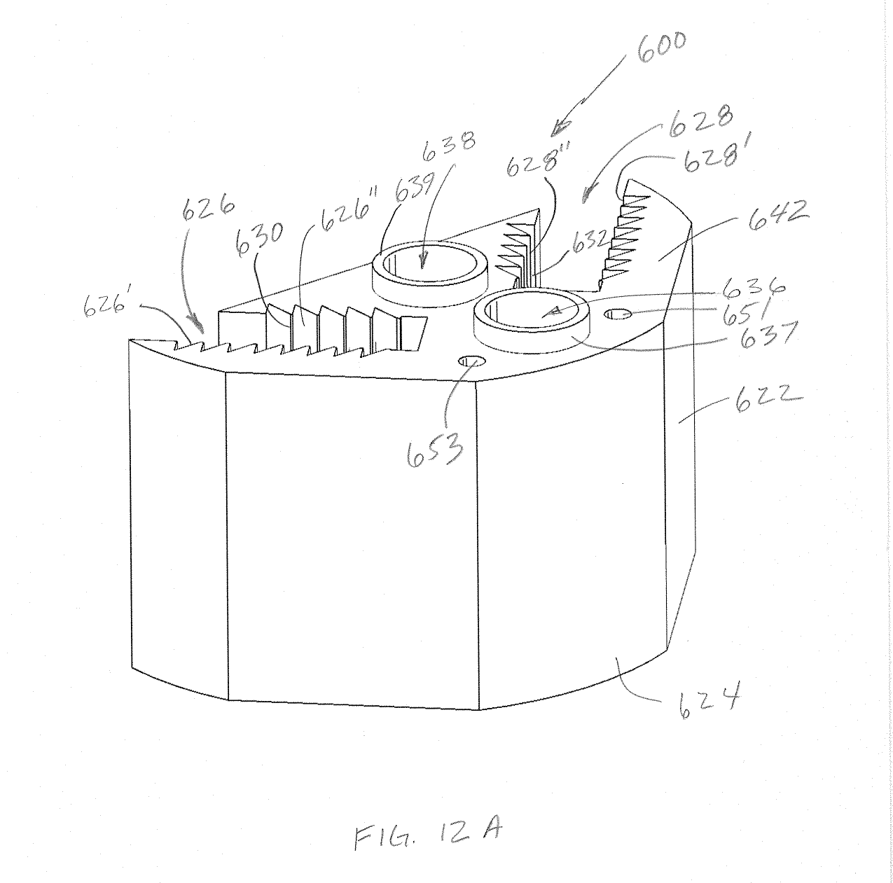

FIGS. 10A and 10B illustrate still another embodiment of a raised garden bed corner bracket 300 in accordance with the principles of the present invention. The corner bracket 300 is similar in configuration as the corner member 12 illustrated in FIG. 2A. That is, the outer surface 322 of the corner bracket 300 forms a partial cylinder wall 324 having a height that is substantially equal to a height of a corresponding plank member (see FIG. 1). For example, and not by way of limitation, the height of the wall 324 may be 3.5 inches to match a height of a standard 1 in.×4 in. wood board or 5.5 inches to match a height of a standard 2 in.×6 in. wood board available at most lumber stores.

The corner bracket 300 defines a pair of plank slots 326 and 328 sized to receive a respective plank member (see FIG. 1). Each slot 326 and 328 is generally rectangular shaped. The inner surfaces 326′ and 326″ of slot 326 include a plurality of vertically extending protrusions or teeth 330 that are configured to engage with respective side walls of the plank member inserted therein (see FIG. 1) in order to securely hold the plank member relative to the slot 326. Similarly, the inner surfaces 328′ and 328″ of slot 328 include a plurality of vertically extending protrusions or teeth 332 that are configured to engage with respective side walls of the plank member inserted therein (see FIG. 1) in order to securely hold the plank member relative to the slot 28. The teeth 330 and 332 are vertically oriented to resist horizontal separation between the corner bracket 300 and respective plank members retained in the slots 326 and 328.

In order to vertically align the corner bracket 300 with an adjacent corner bracket 300 when stacked (see for example FIG. 1), a hexagonal protrusion 340 is provided on the top surface 342 of the corner bracket 300. The protrusion 340 is positioned on the top surface 342 and sized to be received within a hexagonal recess 344 formed in the bottom surface 346 of the corner bracket 300 of an adjacent corner bracket. The hexagonal shape of the protrusion 340 when engaged with the hexagonal recess 344 retains stacked corner brackets 300 in rotational orientation relative to one another so that the inner surface 350 of the corner bracket 300 will be vertically aligned with the inner surface 350 of an adjacently stacked corner bracket. This engagement of the protrusion 340 with the recess 344 of another corner bracket also prevents stacked corner brackets from twisting relative to one another.

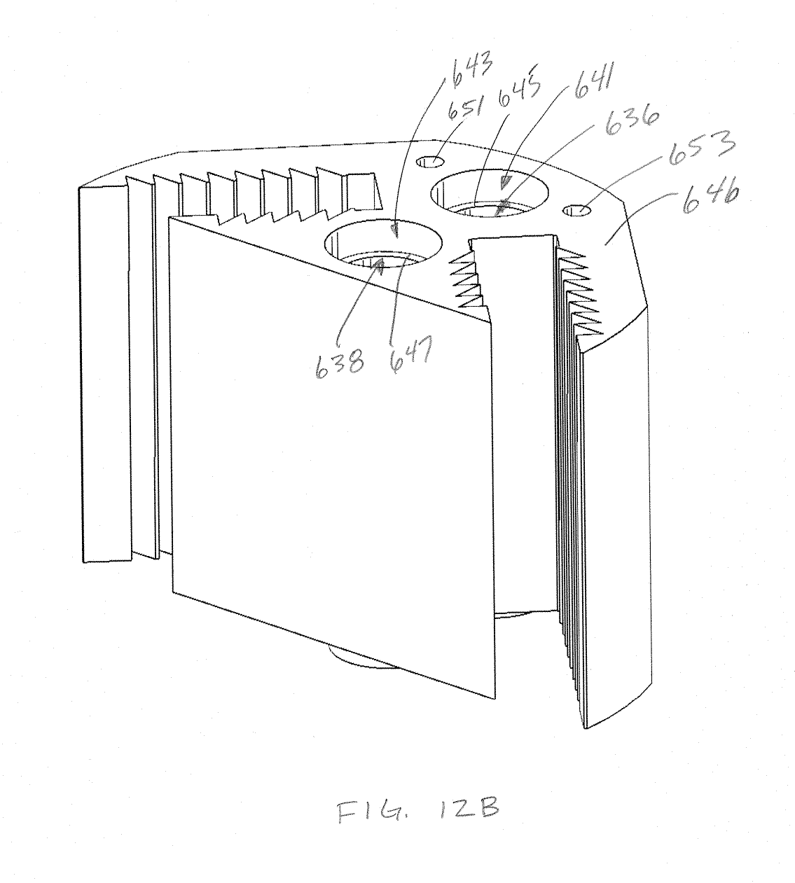

As shown in FIG. 11, when assembled, corner brackets 500 according to the present invention can be stacked upon one another. Inserting a plurality of planks 502 between respective corner brackets 500 effectively forms a rectangular garden bed 510 as previously shown and described with reference to other embodiments herein. As also previously shown and described, each corner bracket 500 includes a vertically extending hole 512 in an outer portion of the corner bracket 500. When stacked as shown, the vertically extending holes 510 of a set of stacked corner brackets 500 are vertically aligned to allow passage of an elongate support structure, such as vertically oriented pipe members 514. Attached to the top of each pipe member 514 is a three-way pipe elbow 516. The three-way pipe elbow 516 defines three pipe receiving apertures oriented at 90 degree angles to one another. This allows for horizontal pipe members 518 to be inserted between respective three-way pipe elbows 516 to form an upper support frame 520. The support frame 520 can then be used to support vertical fencing in order to prevent small animals from entering the garden bed that could damage plants within the garden bed and/or to support materials used to cover the garden bed 510 for plant shading, frost protection, to form a green house over the garden bed 510 or the like.

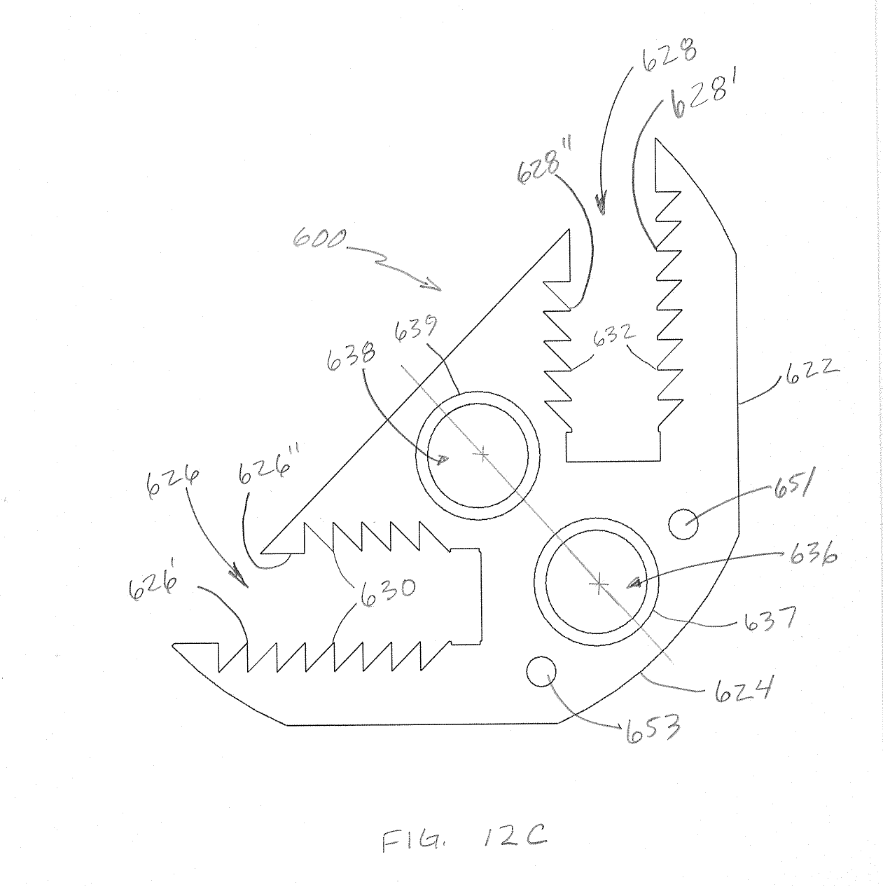

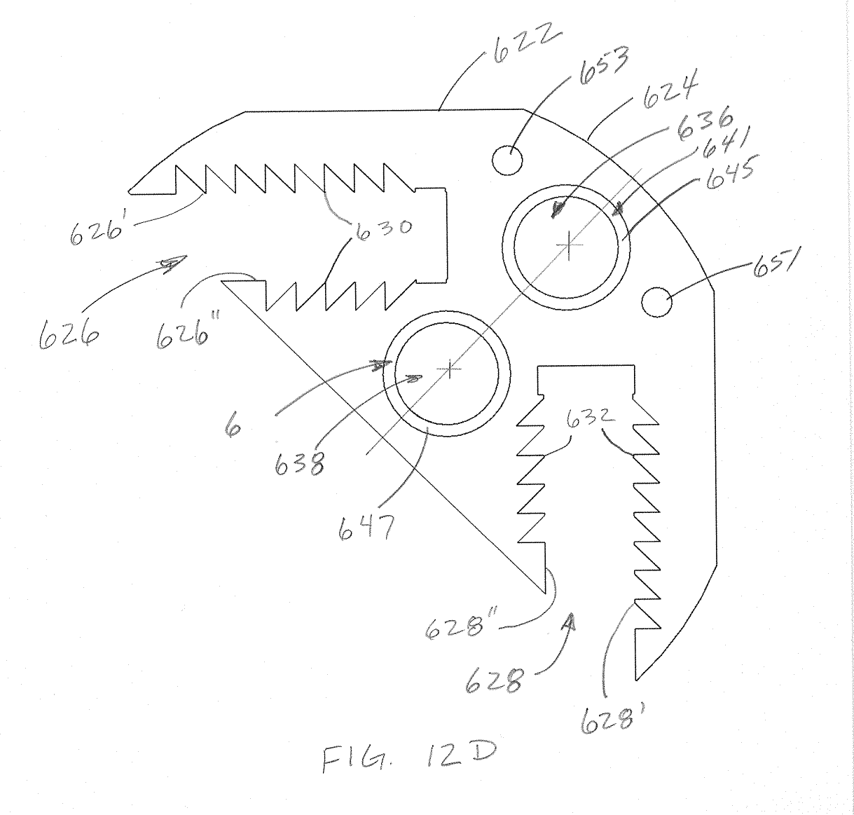

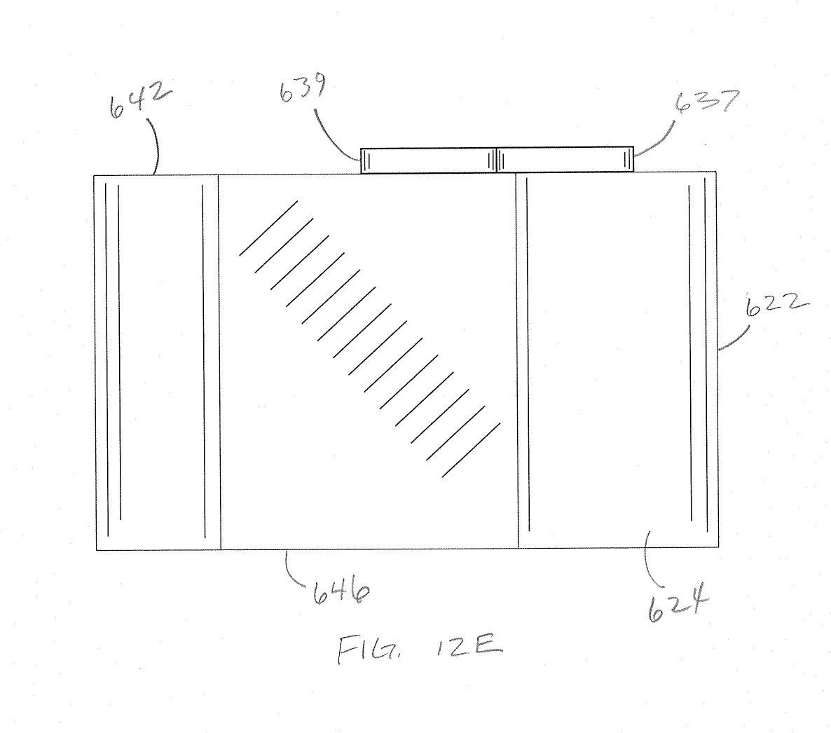

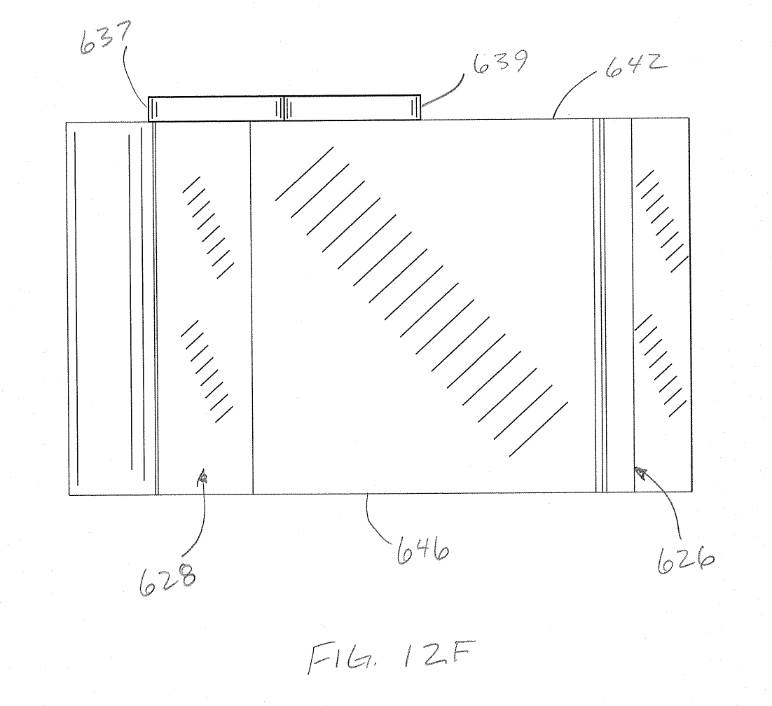

FIGS. 12A-12F illustrate still another embodiment of a raised garden bed corner bracket 600 in accordance with the principles of the present invention. The corner bracket 600 is similar in configuration as the corner bracket 300 illustrated in FIGS. 10A and 10B. The outer surface 622 of the corner bracket 600 forms a partially curved wall 624 having a height that is substantially equal to a height of a corresponding plank member (see FIG. 1). For example, and not by way of limitation, the height of the wall 624 may be 3.5 inches to match a height of a standard 1 in.×4 in. wood board or 5.5 inches to match a height of a standard 2 in.×6 in. wood board available at most lumber stores.

The corner bracket 600 defines a pair of plank slots 626 and 628 sized to receive a respective plank member (see FIG. 1). Each slot 626 and 628 is generally rectangular shaped. The inner surfaces 626′ and 626″ of slot 626 include a plurality of vertically extending recesses that form teeth 630 that are configured to engage with respective side walls of the plank member inserted therein (see FIG. 1) in order to securely hold the plank member relative to the slot 626. Similarly, The inner surfaces 628′ and 628″ of slot 628 include a plurality of vertically extending protrusions or teeth 632 that are configured to engage with respective side walls of the plank member inserted therein (see FIG. 1) in order to securely hold the plank member relative to the slot 628. The teeth 630 and 632 are vertically oriented to resist horizontal separation between the corner bracket 600 and respective plank members retained in the slots 626 and 628. The corner bracket 600 is illustrated as being formed from a single molded piece. In this case, the material used to mold the corner bracket 600 may be plastic, rubber or other relatively rigid materials known in the art. The teeth 630 and 632 and the portions of the corner bracket 600 from which the teeth depend may have some slight flexibility so as to allow insertion of a respective plank (not shown) while maintaining an interference fit between the teeth 630 and 632 and respective planks to securely hold the planks to the corner bracket 600. For example, and not by way of limitation, the teeth 630 on opposite sides of the slot 626 may be spaced apart slightly less (e.g., 0.1-0.05 inch) than a width of a plank to be inserted therein. That is, for a bracket 600 sized to receive a 1.5 inch width plank in the slots 626 and 628, the distance between teeth 630 on opposite sides of the slot 626 and the teeth 632 on opposite sides of the slot 628 may be about 0.05-0.10 inches less than 1.5 inches to ensure an interference fit between the teeth 630 and 632 and respective planks inserted therein between.

In order to vertically align the corner bracket 600 with an adjacent corner bracket 600 when stacked (see for example FIG. 1), the corner bracket 600 is provided with a pair of vertically extending bores 636 and 638. As previously discussed, the vertically extending bores 636 and 638 are sized to receive vertically extending rods (e.g., rod 19 shown in FIG. 1) that connect and align the corner brackets 600 together when vertically stacked. As shown in FIG. 12A, the bore 636 is surrounded by a cylindrical protrusion 637 that extends from the top surface 642 of the bracket 600. Likewise, the bore 638 is surrounded by a similar cylindrical protrusion 639 that also extends from the top surface 642 of the bracket 600. As shown in FIG. 12B, a cylindrical recess 641 is formed in the bottom surface 646 of the bracket 600 that is coextensive and concentric with the bore 636. Likewise, a cylindrical recess 643 is also formed in the bottom surface 646 of the bracket 600 that is coextensive and concentric with the bore 638. The recesses 641 and 643 having a diameter that is greater than the diameters of the respective bores 636 and 638 and are sized to receive the protrusions 637 and 639, respectively, when multiple corner brackets 600 are vertically stacked such that the cylindrical protrusions 637 and 639 are received within and engage with the cylindrical recesses 641 and 643. Circular lips 645 and 647 thus form the bottoms of the recesses 641 and 643, respectively. Once engaged, brackets 600 in stacked form resist horizontal twisting relative to one another so as to maintain their vertically aligned arrangement.

As further illustrated the bracket 600 is provided with a pair of smaller bores 651 and 653 that vertically extend through the bracket. The bores 651 and 653 are spaced on opposite sides of the bore 636. If desired, smaller rods can be inserted through the bores 651 and 653 to interconnect brackets 600 in a stacked arrangement. Thus, the bracket 600 can accommodate various diameters of rods to secure the brackets 600 together when stacked. Also, when using smaller rods in the smaller bores 651 and 653, the engagement of the cylindrical protrusions 637 and 639 with the cylindrical recesses 641 and 643 still provide stability from horizontal movement between stacked brackets 600.

While FIGS. 12A and 12B show perspective top and bottom perspective views of the bracket 600, FIGS. 12C-12F show top side, bottom side, front side and back side views, respectively of the bracket 600. As shown in FIGS. 12C and 12D, the left and right sides of the bracket 600 are symmetrical (i.e., mirror images of one another) about a line that passes through the centers of the bores 636 and 638.

There is thus disclosed an improved raised garden bed system and method of using the improved raised garden bed system. In the foregoing specification, the present invention has been described with reference to specific exemplary embodiments. Various modifications and changes may be made, however, without departing from the spirit and scope of the present invention as set forth in the claims, including combinations of elements of the various illustrated embodiments. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The phrase “consisting essentially of” as used herein is intended to cover additional elements or functions that do not materially affect the basic and novel characteristics of the claimed invention. Thus, “consisting essentially of” is intended to encompass not only those components specifically listed, but also separate or additional components that do not materially alter the specifically recited functions or elements.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A raised garden bed, comprising:
a first plurality of corner brackets, each of the first plurality of corner bracket defining a first slot and a second slot, the first and second slots oriented at an angle relative to one another of between 30 degrees and 150 degrees; and
a first plurality of planks, each of the first plurality of planks inserted into the first slot of one of the plurality of corner brackets and the second slot of another of the plurality of corner brackets to form a raised garden bed.

2. The raised garden bed of claim 1, further comprising:
a second plurality of corner brackets, each second corner bracket defining a first slot and a second slot, the first and second slots oriented at an angle relative to one another that is the same as the angle of the first and second slots of the first corner bracket, the second plurality of corner brackets stacked upon the first plurality of corner brackets; and
a second plurality of planks, each second plank inserted into the first slot of one of the second plurality of corner brackets and the second slot of another of the plurality of second corner brackets, the second plurality of planks stacked upon the first plurality of planks.

3. The raised garden bed of claim 1, wherein each of the plurality of corner brackets comprise a body having a first surface, a second surface opposite the first surface, an outer wall and an inner wall, the inner and outer walls having a wall height between the first surface and the second surface, the first slot comprising a first vertically oriented and generally rectangular slot defined by the body between the outer wall and the inner wall at a first side of the body and extending between the first surface and the second surface and the second slot comprising a second vertically oriented and generally rectangular slot defined by the body between the outer wall and the inner wall at a second side of the body and extending between the first surface and the second surface.

4. The raised garden bed of claim 3, wherein each of the plurality of corner brackets define at least one vertically oriented bore proximate to and proximately between a first closed end of the first slot and a second closed end of the second slot, the at least one vertically oriented bore extending through the body between the first surface and the second surface.

5. The raised garden bed of claim 4, further comprising at least one rod sized to fit within at least one vertically oriented bore and having a length sufficient to extend from at least the first surface of the body and protrude from the second surface of the body.

6. The raised garden bed of claim 5, further comprising a protrusion on the first surface and a corresponding recess on the second surface that is vertically aligned with and has a similar configuration to the protrusion on the first surface, the protrusion configured to mate with the corresponding recess of a second body when vertically stacked.

7. The raised garden bed of claim 6, further comprising a first plurality of teeth inwardly depending from first inner sidewalls of the first slot and a second plurality of teeth inwardly depending from second inner sidewalls of the second slot, the first and second plurality of teeth configured to engage a respective plank inserted therein between.

8. The raised garden bed of claim 2, wherein the outer wall has a generally curved configuration and extends between a first opening at a first outer side of the first slot and a second opening at a second outer side of the second slot.

9. The raised garden bed of claim 8, wherein the inner wall extends between a first inner side at the first opening of the first slot and a second inner side at the first opening of the second slot.

10. The raised garden bed of claim 5, wherein the at least one vertically oriented bore comprises a pair of vertically oriented bores proximate to and proximately between the first closed end of the first slot and the second closed end of the second slot, the pair of vertically oriented bores extending through the body between the first surface and the second surface.

11. The raised garden bed of claim 10, further comprising a pair of cylindrical protrusions, each concentric with a respective one of the pair of bores, the pair of cylindrical protrusions extending from the first surface of the body and further comprising a pair of cylindrical recesses, each concentric with a respective one of the pair of bores, the pair of cylindrical recesses recessed into the second surface of the body and having a diameter configured to receive a respective one of the pair of cylindrical protrusions from another body stacked thereon so as to engage with and prevent horizontal movement between adjacent bodies in a vertically stacked arrangement.

12. The raised garden bed of claim 11, wherein the at least one rod comprises a pair of rods, each for being received in one of the pair of bores and having a length sufficient to couple a plurality of bodies in the vertically stacked arrangement.

13. A bracket assembly for forming a raised garden bed, comprising:
a body having a first surface, a second surface opposite the first surface, an outer wall and an inner wall, the inner and outer walls having a wall height between the first surface and the second surface;
a first vertically oriented and generally rectangular slot defined by the body between the outer wall and the inner wall at a first side of the body and extending between the first surface and the second surface;
a second vertically oriented and generally rectangular slot defined by the body between the outer wall and the inner wall at a second side of the body and extending between the first surface and the second surface, the first vertically oriented slot having a first long axis that is at an angle of between about 30 degrees and 150 degrees from a second long axis of the second vertically oriented slot;
at least one vertically oriented bore proximate to and proximately between a first closed end of the first slot and a second closed end of the second slot, the at least one vertically oriented bore extending through the body between the first surface and the second surface; and
at least one rod sized to fit within at least one vertically oriented bore and having a length sufficient to extend from at least the first surface of the body and protrude from the second surface of the body.

14. The bracket assembly of claim 13, further comprising a protrusion on the first surface and a corresponding recess on the second surface that is vertically aligned with and has a similar configuration to the protrusion on the first surface, the protrusion configured to mate with the corresponding recess of a second body when vertically stacked.

15. The bracket assembly of claim 14, further comprising a first plurality of teeth inwardly depending from first inner sidewalls of the first slot and a second plurality of teeth inwardly depending from second inner sidewalls of the second slot, the first and second plurality of teeth configured to engage a respective plank inserted therein between.

16. The bracket assembly of claim 11, wherein the outer wall has a generally curved configuration and extends between a first opening at a first outer side of the first slot and a second opening at a second outer side of the second slot.

17. The bracket assembly of claim 16, wherein the inner wall extends between a first inner side at the first opening of the first slot and a second inner side at the first opening of the second slot.

18. The bracket assembly of claim 11, wherein the at least one vertically oriented bore comprises a pair of vertically oriented bores proximate to and proximately between the first closed end of the first slot and the second closed end of the second slot, the pair of vertically oriented bores extending through the body between the first surface and the second surface.

19. The bracket assembly of claim 18, further comprising a pair of cylindrical protrusions, each concentric with a respective one of the pair of bores, the pair of cylindrical protrusions extending from the first surface of the body and further comprising a pair of cylindrical recesses, each concentric with a respective one of the pair of bores, the pair of cylindrical recesses recessed into the second surface of the body and having a diameter configured to receive a respective one of the pair of cylindrical protrusions from another body stacked thereon so as to engage with and prevent horizontal movement between adjacent bodies in a vertically stacked arrangement.

20. The bracket assembly of claim 18, wherein the at least one rod comprises a pair of rods, each for being received in one of the pair of bores and having a length sufficient to couple a plurality of bodies in the vertically stacked arrangement.
